(19) United States
(12) Patent Application Publication
(10) Pub. No.: US 2008/0060770 A1
(43) Pub. Date: Mar. 13, 2008

(54) PANEL TRACK CURTAIN SYSTEM

(76) Inventor: Ian ELLBOGEN, Montreal (CA)

Correspondence Address: OGILVY RENAULT LLP, 1981 MCGILL COLLEGE AVENUE, SUITE 1600, MONTREAL, QC, H3A2Y3, US

(21) Appl. No.: 11/531,324

(22) Filed: Sep. 13, 2006

(51) Int. Cl. E05D 15/06

(52) U.S. Cl. 160/197

(57) ABSTRACT

A curtain system comprising several panels of a flat material, each panel having along a top edge thereof a mounting member including a horizontal slat from which the flat material hangs freely, the slat being provided with fastening members on either end thereof and a central slat body extending therebetween, one end of each said slat being guided in a first common rail and another end of each slat being guided in a second common rail so that the panels at least partially overlap one another, the fastening members of the slats being integrated with the central slat body thereof and include mounting hooks for engagement with displacement members received within the first and second common rails for sliding displacement therewithin.

### TECHNICAL FIELD

The present invention relates generally to a curtain system for hanging several flat panels made, for example, of a curtain material.

### BACKGROUND OF THE INVENTION

Curtain systems which use a plurality of flat curtain panels suspended from several parallel rails are known. Typically, such flat curtain panels are staggered, each sliding on its own support rail. Thus, such curtain panels remain substantially flat, whether the curtain system is open (i.e. exposing the window or door which it covers) or closed. Thus, in comparison with traditional curtains that hang in a serpentine manner, the flat panel systems permit more light to enter a room and also permit other optical effects, such as to provide a given particular a modern ambience.

WO 2004/048738 A1 discloses a flat curtain system having several flat panels, each panel having at the top has a suspension member in the form of a horizontal slat, made of metal, wood or synthetic material, on which the flat panel material hangs freely. Each slat is provided with fastening means for rollers or sliders at one end of the slat which are guided in a first common rail and the rollers or sliders at the other end of each slat are received and guided within in a second common rail. As such, this configuration permits the panels to be partially overlapped, so that the panels can be pushed over one another. However, improvement to his panel curtain system is desired, particularly with respect to the mounting system used to suspend each panel from the two parallel rails or tracks.

### SUMMARY OF THE INVENTION

The object of this invention is to provide an improved panel track curtain system having an improved mounting arrangement for the panels.

It is another object of the present invention to provide a panel track curtain system having a mounting arrangement of the panels thereof that is less expensive to manufacture and reduce the total number of parts of the system, thereby simplifying both manufacture and assembly thereof.

Therefore, in accordance with one aspect of the present invention, there is provided a curtain system comprising several panels of a flat material, each panel having along a top edge thereof a mounting member including a horizontal slat from which the flat material hangs freely, the slat being provided with fastening members on either end thereof and a central slat body extending therebetween, one end of each said slat being guided in a first common rail and another end of each slat being guided in a second common rail so that the panels at least partially overlap one another, the fastening members of the slats being integrated with the central slat body thereof and include mounting hooks for engagement with displacement members received within the first and second common rails for sliding displacement therewithin.

### BRIEF DESCRIPTION OF THE DRAWINGS

Further features and advantages of the present invention will become apparent from the following detailed description, taken in combination with the appended drawings, in which:

FIG. 1 is a perspective view of the curtain system of the present invention having two parallel rails running mounted to the ceiling of a room, from which several flat panels are suspended;

FIG. 2 is a side elevation view of the end of a panel-supporting horizontal slat used to support the flat panels of FIG. 1, the slat end having a hook portion integrated therein for engagement with a slider;

FIG. 3 is a side elevation view of the end of a panel-supporting horizontal slat in accordance with another embodiment, having a hook integrated therein for engagement with a roller;

FIG. 4 is a side elevation view of the end of a panel-supporting horizontal slat of another embodiment, having a hooked wire for engagement with a roller, and a flattened slat into which the hooked wire is integrated;

FIG. 5 is a partial front elevation view of three suspension members including slats in accordance with another embodiment, for supporting three curtain panels mounted thereto on two rails and a pull chain connecting the suspension members, the slats having hooks and pull-chain receiving openings integrated therein.

### DETAILED DESCRIPTION OF A PREFERRED EMBODIMENT

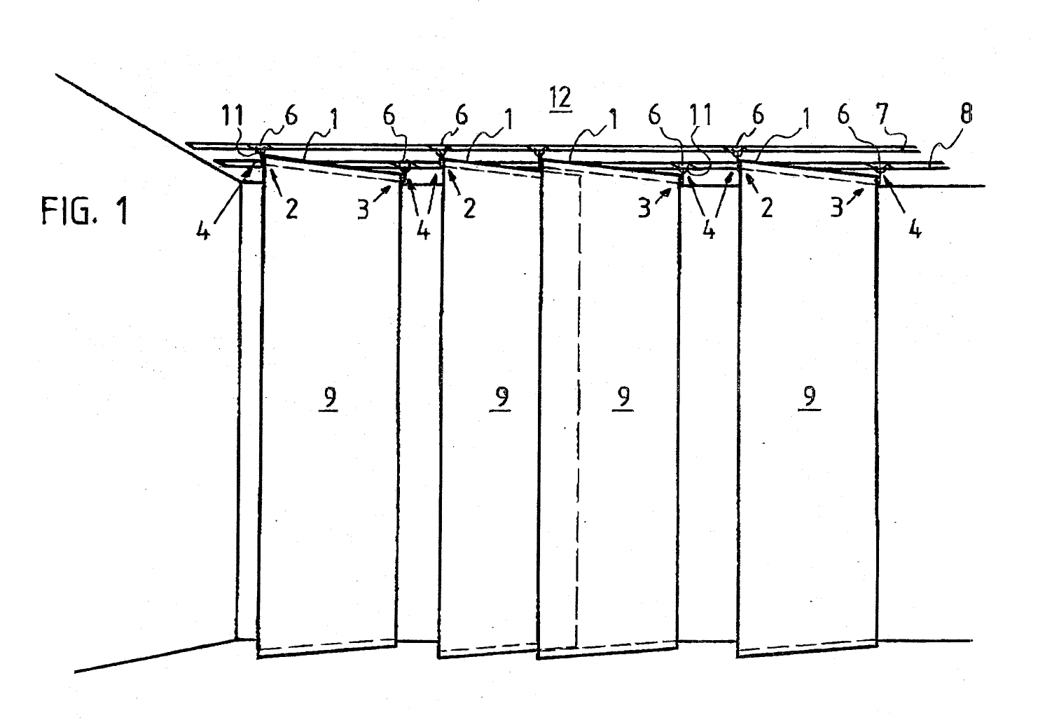

In FIG. 1, the curtain system is shown in use covering a window or door. The curtain system generally comprises a rail assembly with two individual parallel rails 7,8, which are mounted on the ceiling 12 of the room in question. The two rails 7 and 8 provide for the slidable hanging of several flat panels 9. Instead of on the room ceiling, the rail assembly can also be installed on a board arranged lower than the ceiling or alternately itself form such a board. The rails can also be located in a round rod. The two rails 7,8, disposed a relatively small distance apart, run parallel to each other and parallel to the upper corner of the room (i.e. between the wall the ceiling). Each curtain panel 9 comprises a panel carriage with a slat 1, which can be made of metal, wood or synthetic material for example, and a piece of curtain material hung thereon. A hemstitch at the upper edge of the curtain material serves advantageously for the hanging of the curtain material on the slat 1. Using this hemstitch the curtain can then easily be put over the slat 1. The curtain material then hangs freely down and forms the flat panel 9. In order that the curtain material hangs as wrinkle-free as possible, the lower hem can be provided in a known manner with weights, for instance a weight rod inserted in the lower hemstitch. The slat 1 on which the curtain material hangs is provided at both its ends with fastening members 4 which each include a hook that can be hung on the eyelet 11 of a slider 6 which slides within one of the rails 7,8, or which can be hung on the axle of a roller which rolls inside the rails 7,8. Here the left ends 2 of the slats 1 are, in each case, hung with their fastening members 4 engaged with the sliders 6 which slide in the front rail run 7 facing the observer. The right ends 3 of the slats 1 are, in each case, hung with their fastening members 4 engaged with the sliders 6 which slide in the rear rails 8 of the assembly rail. Due to this arrangement, the individual panels 9 hang inevitably at a slightly oblique angle with respect to the running direction of the rails 7,8 and the wall of the room or the window wall behind the curtain. With a panel width of, for example, 50 cm and a spacing of the rails 7,8 of, for example, 2 cm from rail centre to rail run centre, there is an angle of merely 2.3° to the running direction of the rail runs. In the figure, four panels 9 are shown, however it is to be understood that more or less panels may be provided. In this case, the two panels in the middle hang in a position in which they overlap by about a third. Between the outer two panels 9 and the middle two panels 9 a gap of about one third of the width of the panel remains open. All panels 9 can be moved to and fro along the rails 7,8 and the shown position of the panels 9 is merely selected so in order to show the adjustment possibilities. For example, all panels 9 can be slid completely to the left or to the right until they overlap one another and their slats 1 and their hanging curtain materials come to rest against one another. The panels 9 can be slid together completely or only loosely in any position between these end positions. Through this free slidability up to completely overlapping with the adjacent panel, there are many possibilities for creative light effects. The curtain panels 9 can also be easily be moved so that, for example, a window arranged behind it can be opened when required or a balcony or terrace door can be opened and then the passage to the outside is ensured. A pull-cord with additional sliders can serve for this purpose in which case these sliders are fitted between the sliders 6 of the slats 1 in one of the two rails 7,8. The pull-cord catches and displaces with each of its sliders one panel 9 each and can also be provided with a pull rod at least at one of its ends.

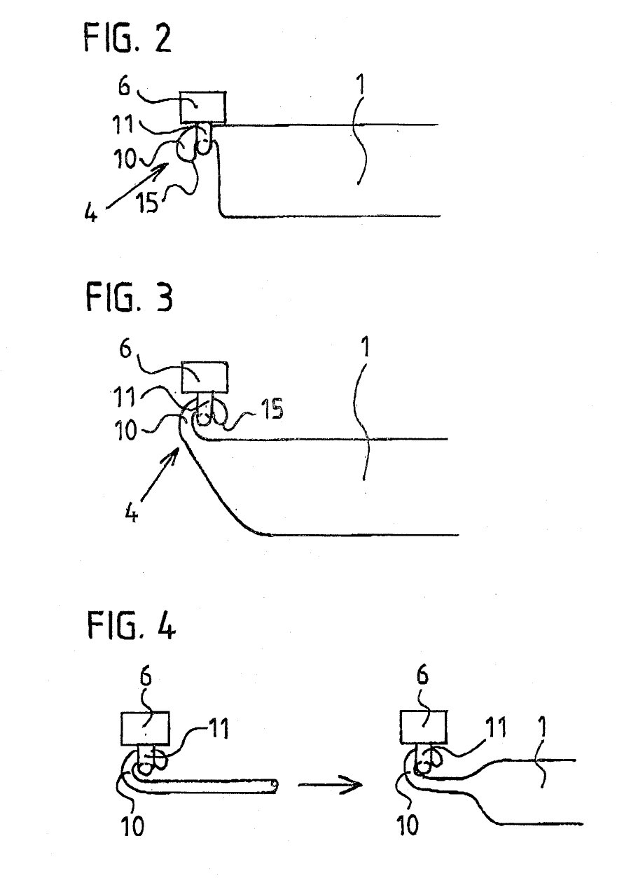

In FIG. 2, the left end 2 of a slat 1 is presented with the fastening member 4 and the sliders 6. The fastening member 4 consists here of a hook 10 which is integrally formed with the elongated main body of the slat 1 that extends between the fastening members on either ends thereof. Preferably, the entire slat 1, including the end fastening members 4, is a sheet-metal strip, and the end fastening members 4 are formed by punching out material from the slat. To improve the stability, the sheet-metal strip can be formed by crimping over lengthwise so that the axis of the seam runs, for example, on the upper side of the slat 1 on which then also the curtain panel hangs with its hemstitch. It is important that the fastening members 4, thus the hooks 10 which are defined therein, are not shaped wider or thicker than the slat 1 itself so that when the slats 1 are displaced at a slightly oblique angle to the curtain rails 7,8, they can be pushed completely against one another and the spacing of the slats 1 is not limited by the fastening members 4. This is ensured by punching out the hooks 10 of the fastening members 4 from the slat. The slider 6 runs in a conventional manner in the rail run of the curtain rail. The end 15 of the hook 10 is shaped in such a way that is curved such that it cannot easily fall out of the eyelet 11 as long as the eyelet runs in the curtain rail and the slat hangs parallel to it in the eyelets 11.

FIG. 3 shows an alternative embodiment which offers the advantage that the curtain panel hangs below the suspension point on the hook 10 on the slat 1 so that the former hangs nicely in a vertical manner. This hook 10 can be manufactured by punching, but also through extrusion of synthetic material together with the slat. In the first case, if the slat consists of a sheet-metal strip, the upper part of the slat is punched away except for the two hooks 10 so that these hooks remain on the upper side of the slat 1. In order to avoid loss of material, the ends of a slat to be provided with hooks 10 can first be rolled flat so that the material at the end is rolled in the direction of the upper slat edge and in this way, at the upper edge, a zone is formed overlapping the edge upwards. A hook 10 is then punched out from this thinned area.

FIG. 4 shows another alternative embodiment in which the suspension slat 1 comprises a bare wire with either round, oval or rectangular cross-section and which has both ends curved upwards by about 270°, thus forming a hook 10 in each. In the case of such a slat produced with zones thereof which remain straight, these can be flattened as desired by means of pressing or rolling as shown to the right of FIG. 4. Alternatively, the zones at the ends of the slat can also be shaped to a hook through bending, pressing and/or punching.

The slats can be made of a rolled, drawn or extruded profile of metal or synthetic material, where in the case of synthetic material it can also be fibre-reinforced. Also a wood strip can be used. For strengthening this wood strip, the strip can also be made laminated. On these slats a hook is then formed at both ends by punching or cutting. If the slat is made of synthetic material injected into a mould, the hooks at the ends can be extruded directly and integrated with the slat in the desired form. Hooks of synthetic material offer the advantage that the ends of the hooks can be guided close to the upper edge of the slat in which case, due to the flexibility of the synthetic material, the end of the hook can easily be twisted so that an eyelet can be fitted on and afterwards, due to the elastic rebounding of the hook, the eyelet is secured from slipping off.

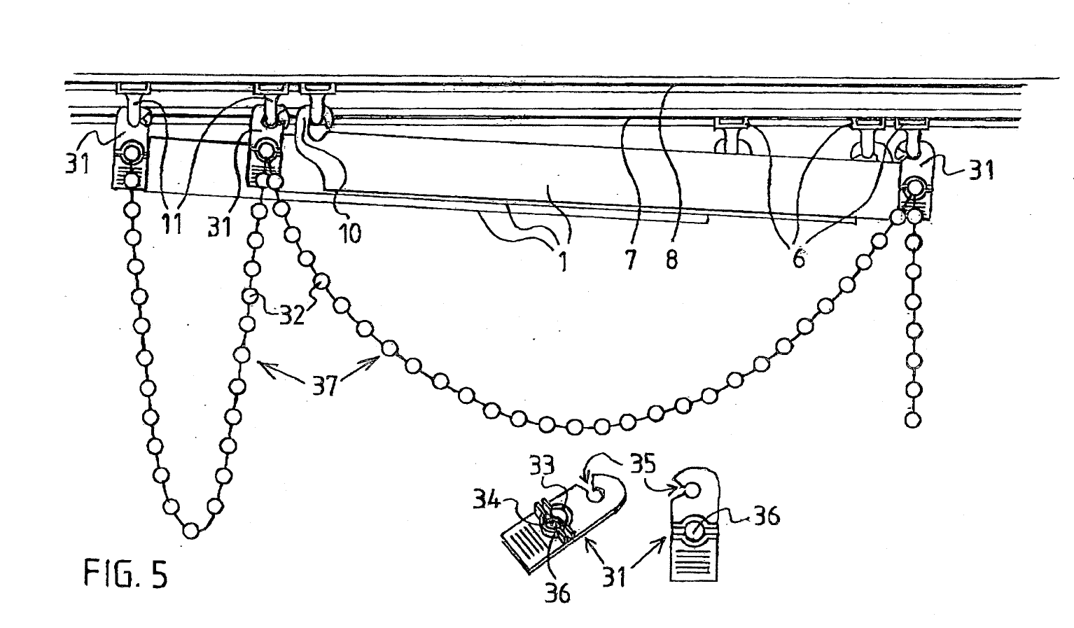

FIG. 5 shows three slats 1 of which one end hangs in each case on a slider 6 in the rail 7 and the other end hangs in the same manner in the second rail 8. This figure helps one understand how the individual slats 1 interact. Therefore, the slats are shown in FIG. 5 without their associated curtain panels in place. In addition, pull elements 31 are fitted in the eyelets of the sliders 6. Two such pull elements are shown separately and on a somewhat larger scale below the figure. These are small plates of synthetic material with a hook which has a tapering opening 35 so that such a pull element 31 can be clipped on, while slightly spreading apart the upper side of the hook, over the eyelet 11 of a slider 6 and is secured thereon. Moreover, on this small plate 31 two approximately semicircular shells 33,34 are formed which can be spread elastically somewhat apart from one another and between these two shells 33,34 there is a hole 36 which goes through the small plate. Between these two shells 33,34 a small ball 32 of a chain 37 can be clipped in so that it is clamped between these two shells. A ball chain 37 with small balls 32, which are placed on a cord passing through them, can thus interconnect, in the shown manner, the individual slats 1 of a curtain arrangement with one another. The slat 1 which is to the very right in the figure is the slat at one end. To its outer end a pull element 31 is attached to which the chain 37 with the small balls 32 is fastened. The chain 37 is afterwards led to the opposite end of the next slat 1 and clipped on there in the same manner to a suspended pull element 31. From there the chain 37 leads further to the opposite end of the subsequent slat 1 and is there again clipped on in the same manner to a suspended pull element 31. If further slats 1 follow, the chain 37 would always be suspended on their opposite ends. The pull elements 31, having the clipping means for engaging the pull chain 37, can also be integrated directly into the slats 1, for example by forming the holes 34 and the opposed ball-gripping shells 33,34 directly into the slat material. These may be, for example, simply replaced simply with an opening or hole formed through the ends of the slats, to which an attachment member may be fastened which engages the pull chain.

Therefore, to open or slide aside the finished panel curtain, the chain 37 can be gripped at one end (at the right in FIG. 5) and pulled (to the left in FIG. 5). In this case, the left slider of the first slat 1 (which is to the very right in the figure) pushes against the left slider of the following, and this slider 6 comes finally to rest against the left slider 6 of the slat 1, which is to the very left in the figure, and so forth. To draw the curtain panel, the chain 37 (in this example) can be pulled to the right. It is then tensed little by little and pulls the following slat 1 from its opposite end in the figure towards the right. The length of the chain between two fastening points is selected advantageously in such a way that when the chain is tensed the panels or slats 1 overlap somewhat.

To install such a panel-track curtain system—if conventional sliders 6 without locking lips or roller pairs are used—the individual slats 1 with hanging panels thereon are first hung with their hooks 10 at the end in the eyelets 11 of the slider 6 or the hooks are hung on the roller axles 13. In this state, a slat 1 is then caught and rotated downwards approximately in the plane of the panel. Afterwards, the upper slider or the upper roller pair is inserted in a conventional manner in the end zone of a rail run 8 of a curtain rail through an opening there on the underside of the rail run in the inside of the latter and moved therein by a distance of the length of the slat 1. The slat 1 is then rotated upwards again around the eyelet 11 of the upper slider or around the axle 13 of the upper roller pair and the second slider or the second roller pair is inserted in the other rail run 7.

The embodiments of the invention described above are intended to be exemplary. Those skilled in the art will therefore appreciate that the forgoing description is illustrative only, and that various alternatives and modifications can be devised without departing from the spirit of the present invention. Accordingly, the present is intended to embrace all such alternatives, modifications and variances which fall within the scope of the appended claims.

1. A curtain system comprising several panels of a flat material, each panel having along a top edge thereof a mounting member including a horizontal slat from which the flat material hangs freely, the slat being provided with fastening members on either end thereof and a central slat body extending therebetween, one end of each said slat being guided in a first common rail and another end of each slat being guided in a second common rail so that the panels at least partially overlap one another, the fastening members of the slats being integrated with the central slat body thereof and include mounting hooks for engagement with displacement members received within the first and second common rails for sliding displacement therewithin.

2. The curtain system as defined in claim 1, wherein the mounting hooks are formed at both ends of the slats by one of punching and cutting.

3. The curtain system according to claim 1, wherein that the slats include one of a rolled, drawn or extruded metal profile.

4. The curtain system according to claim 1, wherein the slats include an extruded synthetic material profile.

5. The curtain system according to claim 1, wherein the slats include a wood strip or laminated wood strip profile.

6. The curtain system according to claim 1, wherein the slats include an extruded synthetic material profile.

7. The curtain system according to claim 1, wherein the slats are made of one of metal, wood and synthetic material.

8. The curtain system according to claim 1, wherein the slats are formed by a bare wire, of which both ends thereof are curved upwards and thus integrally form the mounting hooks.

9. The curtain system according to claim 8, wherein predetermined zones of the slats are flattened by means of one of pressing and rolling.

10. The curtain system according to claim 8, wherein the bar wire has one of around, oval and rectangular cross-section.

11. The curtain system according to claim 8, wherein the mounting hooks are formed by one of bending, pressing and punching.

12. The curtain system according to claim 1, wherein the displacement members include at least one of rollers and sliders.

13. The curtain system according to claim 1, wherein said fastening members include mounting points for engagement with a pull chain used to displace the slats, such that several of the fastening members can be interconnected by the ball chain.

14. The curtain system according to claim 13, wherein the mounting points are integrated into the slats.

15. The curtain system according to claim 14, wherein pull elements are engaged to the mounting points, the pull elements being engageable to the pull chain.

16. The curtain system according to claim 15, wherein the pull elements include means for engaging a ball of the ball chain.
